(19) United States
(12) Patent Application Publication
(10) Pub. No.: US 2002/0013831 A1
(43) Pub. Date: Jan. 31, 2002

(54) System having mobile terminals with wireless access to the internet and method for doing same

(76) Inventors: Arto Astala, Vantaa (FI); Timo Ellila, Halikko (FI); Petri Asunmaa, Espoo (FI); Kimmo Djupsjobacka, Palo Alto, CA (US); Anders Frisk, Menlo Park, CA (US); John Grundy, Menlo Park, CA (US); Ilari Saarikivi, Salo (FI); Otso Ylonen, Salo (FI); Martha Zimet, Santa Cruz, CA (US); Sampo Savolainen, Espoo (FI); Patrik Lindblom, Lexington, MA (US); Tapio Mansikkaniemi, Espoo (FI); Thomas Abrahamsson, Linkoping (SE)

Correspondence Address: JUBIN DANA, NOKIA INC., 6000 CONNECTION DRIVE, MD 1-4-755, IRVING, TX, 75039, US

(21) Appl. No.: 09/755,584

(22) Filed: Jan. 5, 2001

Related U.S. Application Data
(63) Continuation-in-part of application No. 09/609,581, filed on Jun. 30, 2000.

(51) Int. Cl. G06F 15/177; G06F 15/16

(52) U.S. Cl. 709/220; 709/203

(57) ABSTRACT

A system and method are provided for allowing a user to perform information management tasks and access the Internet (26). The system includes at least one terminal (20, 21)that is part of a group and capable of wireless communication, an Access Provider (AP) unit (22), an Internet Service Provider (ISP) (24), a server (28) for authenticating the terminal (20, 21), and a global unit (34)for providing the internet address of the server (28) to the terminal (20, 21). The method includes the steps of powering on the terminal (20, 21), establishing a communication link with a gateway to obtain an internet address for the terminal (20, 21) relative to an internet address of the gateway, obtaining an internet address for the server (28), and establishing a shared communication session between the terminal (20, 21) and the server (28) to allow access to information management services.

### CROSS REFERENCE

This application is a continuation-in-part of U.S. application Ser. No. 09/609,581 filed Jun. 30, 2000.

This application relates to U.S. application Ser. Nos. 09/607,359 filed Jun. 30, 2000, Ser. No. 09/607,638 filed Jun. 30, 2000, Ser. No. 09/607,369 filed Jun. 30, 2000, and Ser. No. 09/659416, filed Jun. 30 2000, all of which are incorporated herein by reference.

### BACKGROUND

This invention relates generally to communication networks, and more specifically, to mobile terminals in a network with information management services and Internet accessibility.

Known methods of providing access to the Internet include connecting to the Internet through an Internet Service Provider (ISP). Typically, a user selects one ISP and uses that ISP to gain access to the Internet. In order to gain access to the Internet through the ISP, the user must have a terminal capable of connecting to the ISP. Additionally, the terminal must also have the ability to retrieve information from the Internet. For example, a typical Personal Computer (PC) has a communication port with a communication device, such as a modem, that can connect to the selected ISP via a landline. Once connected, the PC has an internet navigational tool, such as a web browser, stored in the PC's memory, which the user uses to navigate through the Internet to retrieve and display, on a typical monitor, the desired information. However, the limitation of such a system is being able to provide cost effective portability and mobility. For example, a portable PC or laptop computer can be carried from one location to another, but accessing the Internet or other related services typically requires costly connection fees and charges, such as fees charged by the hotel.

Currently known solutions for providing a user with a more portable and mobile unit is the use of a wireless unit, which is a thin device. A thin device is a device having most of the functionality stored and carried out remotely. For example, a thin device would not have its own internet or web browsing capability; it would rely on a remote service provider. Given that the user's wireless unit is a thin device, it depends entirely on a remotely located system for interaction with other services, such as the Internet, and packaging of the information in a format that is compatible with the user's wireless unit. The wireless unit interfaces with the system, which has the ability to package and transmit information to the wireless unit. Typically, the system has Internet accessibility and navigational capability; the system retrieves, packages, and transmits information from the Internet to the wireless unit. In order for the wireless unit to receive the information, the system must package the information for the wireless unit. For example, the system is connected to the Internet, retrieves information from the Internet, and packages that information so that the information is compatible with and can be wirelessly transmitted to the wireless unit.

Since the user's wireless unit is a portable unit, then there is a good chance that the user's wireless unit will enter a second network that is not in communication with the system that provides the wireless unit with the desired data. Consequently, if the wireless unit is operating in the second network and there is no system capable of packaging and transmitting the requested information to the wireless unit, then the wireless unit is of little use.

Other problems presented by using the wireless unit is that the user is not capable of sharing information with other users, storing and retrieving information specific to the user from any wireless unit, and having multiple users that access the same information using the same wireless unit while allowing individual access for each user through the shared wireless unit. For example, the user is not able to view or retrieve calendar information for other users that may be grouped with the user. Furthermore, the user is not able to lend the wireless unit to a second user and have the second user be able to access information individual to the second user.

Therefore, what is needed is a network with at least one mobile terminal that provides information management and internet accessibility, wherein the terminal can be grouped with other terminals through a remotely located server, which contains general grouping information and data that can be accessed by the terminals regardless of the geographical location of the terminal relative to the server.

### SUMMARY

A system and method are set forth with mobile terminals that provide information management and Internet accessibility to a user. The terminals can be grouped through a remotely located server, which contains general grouping information and data that can be accessed by the terminals.

The system is within a network that provides a user with a communication session that includes information management services and Internet access. The system includes at least one terminal that is part of a group and capable of wireless communication, a gateway coupled to the terminal, an access provider (AP) for providing network connection for the terminal to a gateway, an Internet Service Provider (ISP) coupled to the gateway for providing Internet access, and a server coupled to the gateway for providing information management services. Either the AP or ISP can authenticate the terminal. The system also includes a global unit coupled to the gateway for providing the internet address of the server to the terminal, wherein activation of the terminal initiates a request for authentication of the terminal in order to establish a shared communication session.

The method for providing a user with wireless access to the internet and information management through the terminal includes the steps of powering on the terminal, establishing a communication link with the gateway to obtain an internet address for the terminal, obtaining an internet address for the server that will be authenticating the terminal, downloading to the terminal the group profile configuration, and establishing a shared communication session between the terminal and the server to allow access to information and services.

The system provides information management and Internet accessibility in such a way that the terminals may be offered web browser capabilities, while serving each user session, independent of other similar terminals through a remotely located server. The server may be a shared resource with the group members and each individual terminal user.

The system allows for the administrator of a group to be changed to another user terminal of the group.

Several alternative network configurations are a possibility when a different number of providers are involved on a network side, offering services to the group of terminals. It is possible to have authentication of the terminal and initialize the terminal as the terminal, is powered on, performed by any one of several possible units, such as the AP, ISP, or a mobile service provider (MSP).

Furthermore, the AP, the ISP, the Mobile Service Provider, a content provider, or a system product vendor may have specific configuration update rights and the ability to support a configuration change whenever there is reconfiguration and or the network is re-arranged. Thus, problems associated with having an error in URL links that are configured but not updated in the user interface view is prevented/avoided.

An advantage to the present system and method is a cost effective and secure solution is provided for complete portability that allows full access to the internet and information management service, which can be either at a group level or an individual level.

### BRIEF DESCRIPTION OF THE DRAWINGS

FIG. 1 is a block diagram representation of a network that includes mobile terminals capable of communicating with a server.

FIG. 1b is a block diagram representation of a network of mobile terminals capable of communicating with a server.

FIG. 2 is a block diagram representation of the server of a system of the network of FIG. 1.

FIG. 3 is a block diagram of the mobile terminal that operates within the network of FIG. 1.

FIG. 4 is a flowchart of the process for establishing a shared session and an individual session between the mobile terminal and the server of FIG. 1.

FIG. 5 is a flowchart of the process for establishing a communication link between the mobile terminal and the server.

FIG. 6 is a block diagram of an address storing scheme.

FIG. 7 is a signaling flowchart for creating a new profile for a consumer.

FIG. 8 is a signaling flowchart for reading a profile of a consumer.

FIG. 9 is a signaling flowchart for updating a profile of a consumer.

FIG. 10 is a signaling flowchart for removing a profile of a consumer.

FIG. 11 is a signaling flowchart for logging “in” at a family level.

FIG. 12 is a signaling flowchart for logging “in” at an individual or personal level.

FIG. 13 is a signaling flowchart for a software (SW) release distribution from a global source.

FIG. 14a is a signaling flowchart of a terminal SW upgrade.

FIG. 14b is a continuation of the signaling flowchart scheme of FIG. 14a.

FIG. 14b is a continuation of the signaling flowchart scheme of FIG. 14a.

FIG. 15 is a signaling flowchart for a consumer using an application.

FIG. 16 is a signaling flowchart for a consumer accessing and surfing the Internet with a browser.

FIG. 17 is a block diagram of an operation and maintenance (OAM) management unit and its connections to the server.

FIG. 18 is a flowchart of the automatic process for OAM management.

FIG. 19 is another flowchart of the process for OAM management that is activated after a customer complaint.

### DETAILED DESCRIPTION

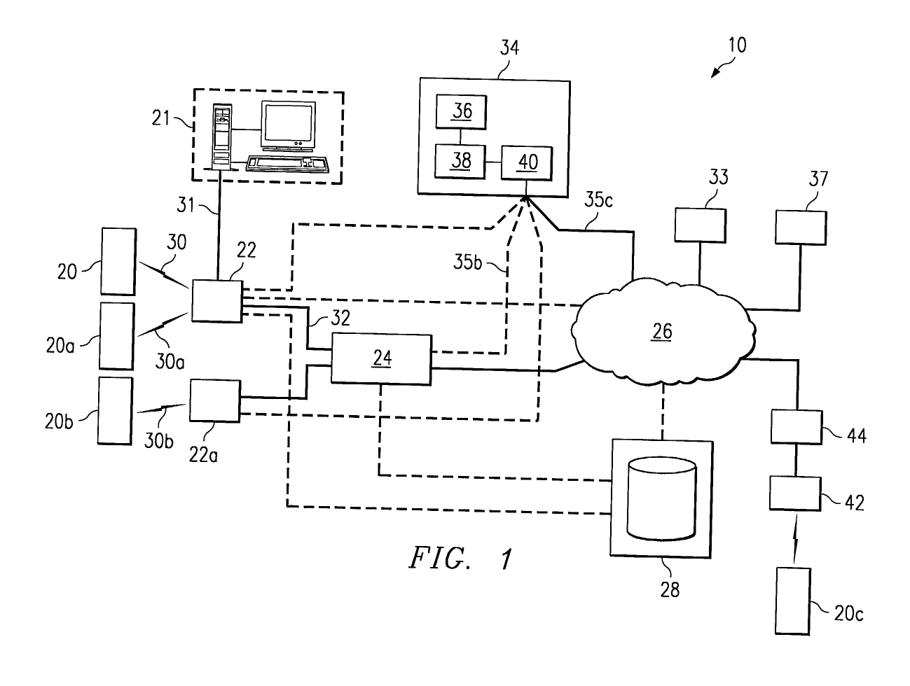

Referring now to FIG. 1, a network 10 includes terminals 20, 20a, 20b, and 20c. For clarity and by way of illustration, reference may only be made to terminal 20 or the terminal 20a, however the teachings set forth herein are applicable to all terminals shown in the Figures set forth herein, except where differences are noted.

The terminal 20 includes a virtual keyboard, and a two-fingered navigational tool, which are the subject of related application serial number U.S. application Ser. No. 09/607359, filed Jun. 30, 2000, entitled “System and Method for Providing a Virtual Keyboard for a Wireless Terminal”, a two-fingered pressure sensitive special click-drag-drop feature, which is the subject of related application serial number U.S. application Ser. No. 09/607638, filed Jun. 30, 2000, entitled “Method and Apparatus for Touchscreen Input”, and a unique Graphical User-interfaces (GUI), which is the subject of related application serial number U.S. application Ser. No. 09/607369, filed Jun. 30, 2000, entitled “User Interface Constructed from Components Created from a Set of Tags″”, all of which are incorporated herein by reference.

The terminal 20 is coupled to an access point at an access provider (AP) unit 22. The terminals 20, 20a, and 20b are coupled to the AP units 22 and/or 22a via wireless connections 30, 30a, and 30b, respectively, and, hence, the user has portable or mobile access to an Internet 26 and services provided by a server 28. The server 28 provides various services, such as email, calendar, notes, the ability to shop on-line, and necessary authentication, as well as third party services and information, which is the subject of related U.S. application Ser. No. 09/659416, filed Jun. 30 2000, entitled “Network With Mobile Terminals As Browsers Having Wireless Access To The Internet And Method For Using Same”, which is also incorporated herein by reference. Additionally, a personal computer (PC) terminal 21 is coupled to the access point of the AP unit 22 via a landline 31. The terminal 21 can be used to access the server 28 using special authentication by any user authorized to access the information and services provided by the server 28. However, the authentication procedure for the user using the terminal 21, which is discussed herein, is different from the authentication procedure for the terminals 20, 20a, and 20b.

The terminal 20 is coupled to the access point of the AP unit 22 using a Wireless Local-Area-Network Gateway (WLAN GW) that is installed at a specific location, such as the user's premises or location. In one embodiment, the WLAN GW interface uses Ethernet 802.11 transfer protocol. However, other wireless interface protocols, such as GPRS of Global System for Mobile Communications (GSM+), Universal Mobile Telecommunication Systems (UMTS), or other LAN may be used without limiting the spirit and scope of the present invention as set forth in the claim. If the terminal 20 is powered on and within range of the transceivers of the AP unit 22, then Ethernet protocol is used as a transfer protocol in order to establish and maintain a communication link at a shared level or an individual level. The terms “shared”, “group”, and “family” are used interchangeably. Also, the terms “private” and “individual” are used interchangeably.

The AP unit 22a is similar to the AP unit 22, and thus, the teachings set forth herein apply equally to both units. The access point is a network unit of the AP unit 22 that is coupled to an Internet Service Provider (ISP) 24, which is coupled to the Internet 26. The access point of the AP unit 22 is capable of connecting directly to the Internet 26 as well as to the ISP 24. The terminal 20 can be coupled through a wireless local access network (WLAN) to the AP unit 22. The terminal 20 can be controlled or directed from any remote location via the Internet 26 through the ISP 24. The internet address of the terminal 20 can be received and stored by a Global Address Server (GAS) 34 along with requests for terminal identification and activation. Accordingly, if the terminal 20 did not have the internet address of the ISP 24 known when the request to GAS 34 was made, then the AP unit 22 receives as an answer the internet address of the ISP 24 from the GAS 34. It is possible that a certificate of the AP unit 22 or even the ISP 24 is defined and saved in the terminal 20 when the terminal 20 is sold to the end user.

In another embodiment, the server 28 can be coupled directly to the Internet 26 and, hence, the terminal 20 accesses the server 28 through the Internet 26.

In yet another embodiment, the AP unit 22 is coupled directly to Internet 26 and, hence, the terminal 20 can access the server 28 via the AP unit 22 and the Internet 26.

In yet another embodiment, the terminal 20 may be coupled directly to the server 28 through the access point of the AP unit 22. Alternatively, the terminal 20 or 21 may be coupled directly to the Internet 26 through the AP unit 22 or the ISP 24 when browser functionality of the terminal 20 or 21 is used and terminal group services and user interface configurations of the group are not required during the communication session established between the terminal 20 and the server 28.

Regardless of how the terminal 20 is coupled to the server 28, once the terminal 20 is authenticated, as will be discussed herein, the terminal 20 can function as an internet browser to access the Internet 26 with the additional ability to retrieve services and information from the server 28. Furthermore, the ISP 24 is shown separate from and not acting as the server 28 and vice versa, even though it is possible to combine them into one unit.

Authorization may be done by the AP unit 22 after the login screen is displayed on the terminal 20. Thus, providing the password and the user ID just once enables access to whatever service is used, such as browsing or specific system service, for as long as the terminal 20 is powered on and coupled to the server 28. Thus, the AP unit 22 stores the authorization parameters as long as the terminal 20 is served; reauthorization is not needed as the user switches between the services provided by the server 28. A browser login of the terminal group profile may proceed after the AP unit 22 has completed the authorization of the terminal 20. The certificate of the AP unit 22 may be saved in the terminal 20.

Similarly, the ISP 24 can activate the authorization process after the connection is established to the terminal 20 via the access point of the AP unit 22, which activates authorization by requesting terminal validity from the ISP 24. Accordingly, server 28 is not used for authorization and log-in process; the authorization certificate may be stored in the ISP 24, the access point of the AP unit 22, or even in the terminal 20. The configuration parameters of services used for browser of the group profile may be downloaded to the terminal 20 from the address provided by the ISP 24 as a result of the authorization process. The information that is downloaded to the terminal 20 may also define that login be made without any login parameter(s) required. If a connection re-establishment is made while the ISP 24 still holds the authentication validity information from the previous connection, the authentication process is not required.

In alternative connection authorization cases where connection is not made via the server 28, the server 28 may be requested for the authorization certificates by either the AP unit 22 or the ISP 24 may send the valid certificates in the request message to the GAS 34.

When the authorization method is activated by the access point of AP unit 22, authorization may occur after the login screen is displayed and the user, having provided the password and the user ID, may select individual services from the user interface. If the user wants to stay in the default group services used by each user terminal of the group after logging-in, then the AP unit 22 and the ISP 24 authorizations may be done as described above, without feedback from the user of the terminal 20. Since the ISP 24 stores the authorization parameters for as long as the terminal 20 is coupled to the server 28 and being served, this authorization remains valid for whichever service is used; and the change from one service to another does not require the user to give the authorization information again. The access certificate of the ISP 24 may be stored in the access point of the AP unit 22 or in the terminal 20.

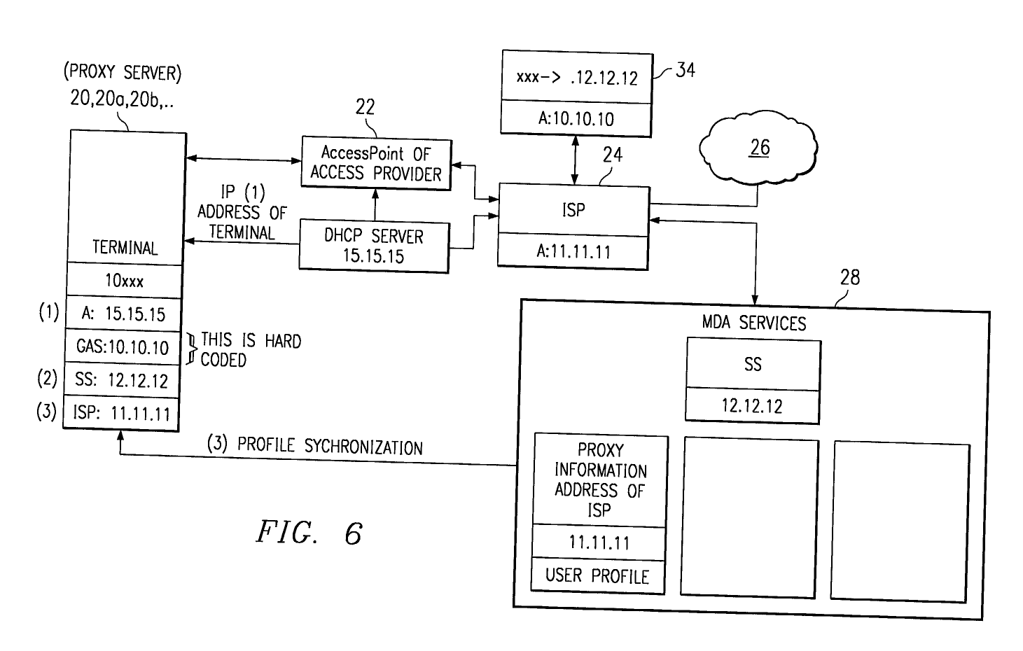

Referring now to FIGS. 1, 1a, and 6, the air interface from the terminals 20, 20a, 20b, etc. to the access point of the AP unit 22 is secure or protected because the air interface security is supported in each possible bearer type to be used. In WLAN, the air-interface is typically protected with standard wire equivalent protection. A shared key ciphering is used in the air-interface protection.

In WLAN, the connectivity from the terminal to the network may be so that firewalls are positioned between the terminal 20 and the network 10 to ensure security of the connections. In WLAN, Hyper-Text Transfer Protocol (HTTP), as well as the secured version of HTTP, called HTTPS, may be used. A firewall can control where, and to, the connections can be routed and made. The firewall requires the communication to be started from the terminal 20 and that the server 28 respond to the initial request for a terminal status server (TSS). The terminal 20 periodically requests any status change that may have occurred. If no change has occurred, then it is possible to transfer payload and control information immediately to the terminal 20, so that bi-directional connection between the terminal 20 and the server 28 is established.

When the terminal 20 is relocated, the existing internet addresses of the AP unit 22, the ISP 24, or the server 28 for the connection associated with the terminal 20 may not support the terminal 20 at the new location because existing TCP/IP connections may be disconnected. In this case, it is necessary to re-establish the internet address and connection, and the authentication process needs to be done again.

Referring now to FIG. 1b, a network 10a has ISPs 24, 24a, and 24b, with each ISP connected to multiple AP units. When a terminal, such as a terminal 20d, is moved to a new position, e.g., to the position corresponding to a terminal 20e, the connection of terminal 20d may be lost. Thus, the internet addresses of the AP unit 22b and the ISP 24 may no longer support the terminal 20 to connect to the server 28 or to the Internet 26 because the TCP/IP connections have been disconnected and changed. Therefore, it is necessary to re-establish the internet address for and connection to an AP unit 22c and the ISP 24a to enable re-connection to the server 28 or the Internet 26 directly from the ISP 24a, and the authentication process must be done again.

When, for any reason, the logical connection is lost between the terminal 20 and the server 28, then the terminal 20 will provide only limited service until the logical connection is re-established.

No input by the user is required after powering on the terminal 20 when the authentication is defined to be done automatically; the ISP 24 stores the required authentication certificates, or the terminal 20 sends the authentication when requesting service.

The user payload or the browsed data content is conveyed via the server 28 making content filtering and content transformation possible. In an alternative embodiment, the browsed payload is transported via the ISP 24, 24a, or 24b without going through the server 28, and thus, without producing traffic volume to the server. Generally stated, if the terminal 20 is powered on and authenticated by the server 28, then information or services from the server 28 are downloaded to the terminal 20. The server 28 downloads information, such as profile settings for the group. One profile setting that can be downloaded is the language preference for a shared communication session. Other information or services may include configuration data, driver or application-related software or portions thereof, configurable parameters, the administrative rights to the shared group profile and the categorization information of the update rights of the configuration parameters of the services and/or the user interface, partial sections of system software, all depending on the level of authentication that has occurred with respect to the user.

The terminal 20 can have access, through proper authentication and service purchases, to third-party publications available from a content provider or vendor 33, such as news-related information found in magazine publications or the daily newspaper. It will be apparent to those skilled in the art that the information may be purchased and transmitted by the vendor 33 upon request from the server 28 and then to all terminals within the group of the terminal 20. Alternatively, the information could be purchased by an operator/owner of the server 28 and then resold to each group as requested. Thus, a group profile can also include access to the information services of the vendor 33 that can be made available to the group or just the individual user, depending on the level of authentication.

There are two levels of authentication for access to the services and information of the server 28: the group level and the individual level. The group level of authentication is based on the identity of the terminal 20, which is used to initiate a group or shared session. In order to create a group, at least one terminal is needed, but typically there are several terminals that make up a group, such as terminals 20, 20a, 20b, 20c, etc. and each terminal has a unique identity that allows it access to a shared session at the group level.

Furthermore, each group includes a specific group profile that is downloaded during a shared session from the server 28. As a result of the download, the terminal 20 may have received at least part or all of the configuration parameters of the services profile and any additional pieces of information that may be defined as required according to the group profile in the ISP 24 or the AP unit 22. The information that is downloaded to the terminal 20 is typically system dependent and may be identical for several terminals. The downloaded information can be country and/or provider dependent, affecting the system services and/or user terminal interface.

Anyone having access to the terminal 20 would have access to the group level information and services, such as calendar, e-mail, bookmarks, cookies, and e-publication. As will be discussed herein, the same services may be available to the user at the individual level, but the content of the information would vary. The server 28 includes capacity for storing data related to the group in a group specific storage unit that can be accessed and used by all terminals within the group, once the terminal has been authenticated and the shared session initiated.

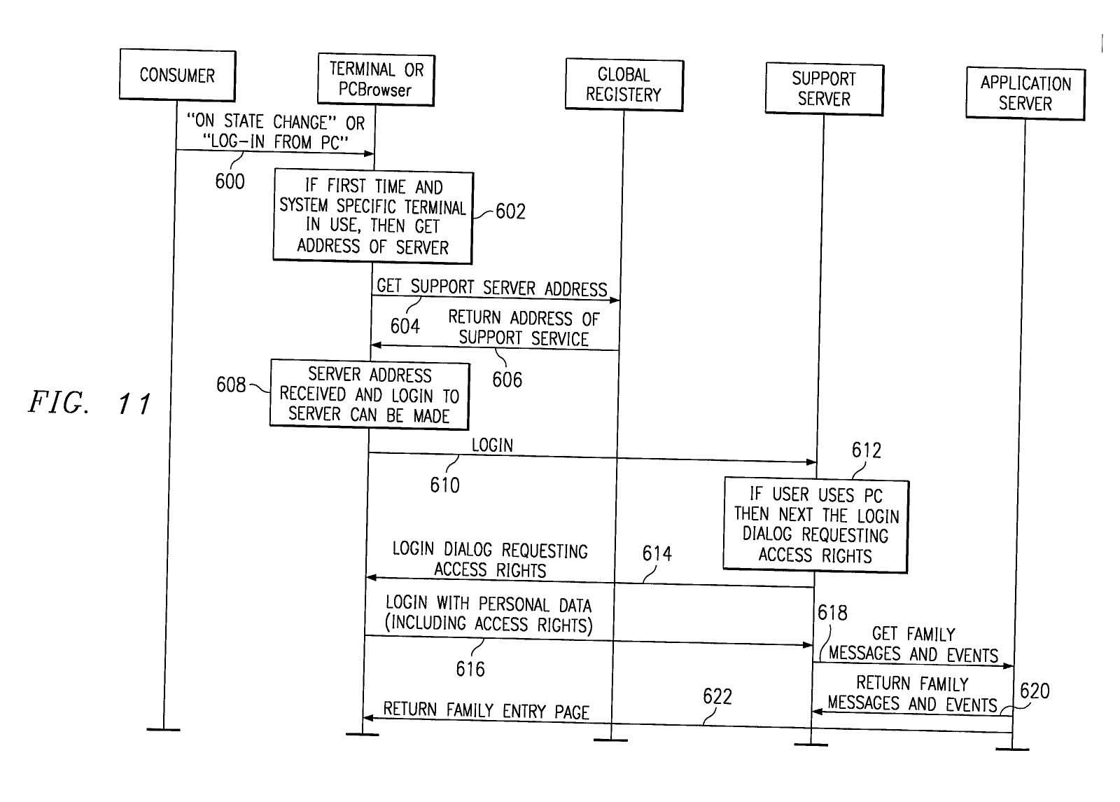

Referring now to FIG. 11, in one embodiment, the group level authentication is based on the identity of the hardware of the terminal 20, and authentication occurs automatically upon initiation of the shared session after power-on as depicted in step 600. Initial power-on or a connection set-up, if a PC is used, takes place at step 602. The address of the server is requested from a global registry in a global address server at step 604. At step 606, a message containing the server address is received and interpreted at step 608. At step 610, the login can proceed. The server recognizes if the terminal belongs to a group, also known as a family. At step 612, if the terminal is a PC, then access rights are requested from the user at steps 614 and 616. The family-specific messages and events information are sent to the server at steps 618 and 620, after which a family entry page is presented in the terminal at step 622.

Even though the authentication at the group level occurs automatically to the AP unit 22, the ISP 24, or the server 28, the scope of the invention as set forth in the claims is not limited thereby. For example, the terminal could require input from the user in order to initiate the group level authentication process. Once the terminal 20 is authorized to access the services, then each user of the terminal is able to access information and services that are available to all users in the group, as well as initiate an individual communication session to access individual information and services available only to that specific user.

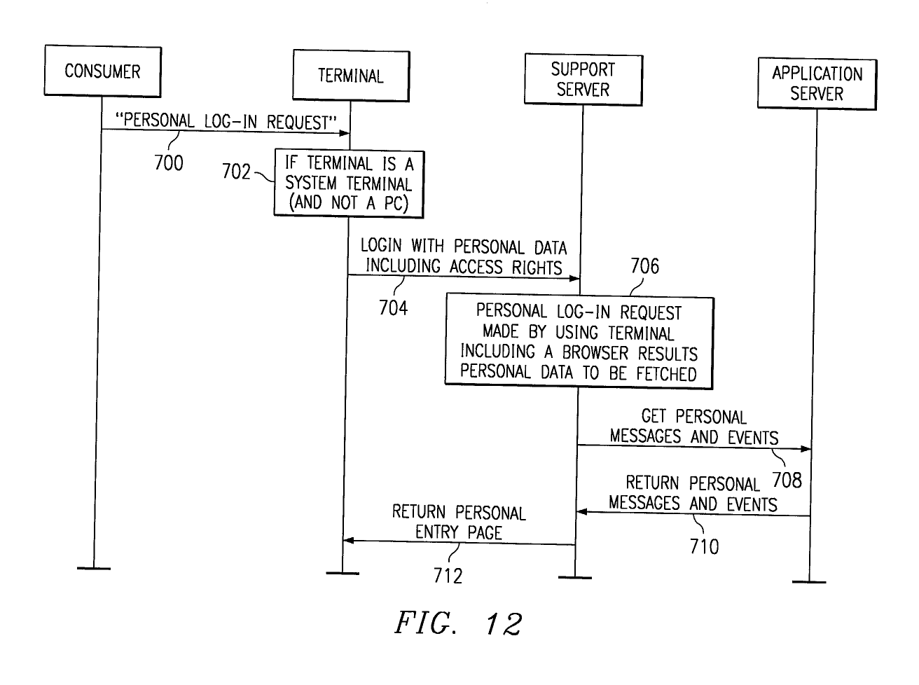

Referring now to FIG. 12, in contrast to a session at the group level, at step 700, an individual session at the individual level requires authentication by way of input from the user at step 704 to access information intended only for that user. At step 702, if the terminal used is a PC, then the access rights are required to be given only once upon initial login. Access at the individual level enables the user access at the family level as well. Upon receiving authentication of access rights at the individual level at step 706, a support server of the server provides the user-specific information at steps 708 and 710. Finally, the terminal receives an individual entry page at step 712. For example, the user could use any terminal within the user's group to initiate an individual session. The authentication can be done using anything that is unique and only known by that user, such as a password. Thus, the user can initiate an individual session regardless of which terminal is being used. When the user activates an individual session, configuration parameters, which are specific to the user, are downloaded to the terminal. Although a user must have a profile associated with the same group as the terminal's group profile, the scope and spirit of the present invention is not limited thereby. For example, a network could be set up to allow a user access from any terminal regardless of the association among the user, the terminal, and the group as long as authentication by the server, the AP unit, or the ISP is accomplished.

Although any user of the terminal can have access to information and services at the group level, only a designated user or a designated number of users can change the group or take actions on behalf of the group. One or more users within the group are typically designated to have administrative rights for the group. The user with administrative rights is called a group administrator. The group administrator has the right to alter the group profile. The information related to the group administrator is stored in the server 28, and administration access can be authenticated by a password. The group administrator, once authenticated, can alter the group profile settings, add or delete terminal profiles from the group profile, and add or delete user profiles form the group profile.

The group administrator can select the language setting for the shared sessions. Each user can select a language preference for the individual sessions. Therefore, in a multilingual group the group language can be different from the language selected by a user for an individual session. Thus, the text language shown in the terminal will depend on whether the group or individual session type has been activated.

Access to purchasing services, such as news or publication services, may be limited to the group administrator. Thus, while all users of the terminal would have access to group level services, such as access to the Internet, they would not be able to make administrative decisions, unless they were authenticated as the group administrator. In addition, different purchase rights may be categorized in several ways to be available to each group member or to just the group administrator. The rules of access rights may be categorized according to, e.g., purchase content type. Accordingly, the group is protected from unauthorized or unwanted alteration of the group profile or financial commitments. This is important because the identity of the user of the terminal is not unknown when the terminal is operating at the group level.

Referring again to FIG. 1, in addition to the ISP 24, the AP unit 22 is also coupled to the GAS 34. In one embodiment, the AP unit 22 may communicate with the GAS 34 through a link 35a. Alternatively, the AP 22 may communicate with the GAS 34 through a link 32, the ISP 24, and a link 35b. In another alternative, the access point of the AP 22 may communicate with the GAS 34 through a landline 32, the ISP 24, the Internet 26, and a link 35c.

The terminal mobile service provider (MSP), which manages a system management or operations and maintenance (OAM) server 37 can be the same or a different organization from the ISP 24. In this logical model, the MSP and ISP are presented as separate sites. The OAM server 37 may be remotely connected with the server 28.

The GAS 34 includes a terminal address register 36, a global upgrade server 38, and a firewall unit 40. It will be apparent to those skilled in the art that the firewall unit 40 functions to provide secure access to the terminal address register 36 and the global upgrade server 38. The terminal address register 36, the global upgrade server 38, and the firewall unit 40, which is protecting the former two, may be owned by the system provider and serve all products worldwide. It may be configured as a distributed global address server that includes several servers connected to each other, e.g., in a mesh structure, and be capable of answering terminal requests made when the terminal is powered on anywhere in the globe where WLAN connection is available.

The internet address of the GAS 34 with the terminal address register 36 is permanently stored in the memory of the terminal 20. Although reference may be made herein to only the internet address of the terminal address register 36 without specific reference to the internet address of the GAS 34, it will be apparent to those skilled in the art that the internet addresses for the two may be the same or slightly different depending on configuration parameters. All the terminals, such as terminals 20, 20a, 20b, 20c, etc. can obtain the internet address of their respective server from the terminal address register 36. Depending on the network configuration and the authentication method applied, the terminal address register 36 may include the address of the server, of the AP unit, and/or the ISP.

The ISP address could be typically used for the terminal and server owner that has a subscription with the ISP, where the ISP is a re-seller or a close contact to the re-seller of the terminal and server system seller. If the terminal and server system re-seller is the AP unit having business in a metropolitan area or anywhere in the country, the address stored in the GAS can be the internet address of the AP unit. If the address in the GAS is the address of AP unit or ISP, then the AP unit or ISP includes detailed register of the customers and addresses of each server that serves each user terminal. Storing the internet address of the terminal address register 36 in the terminal allows an association between the terminal and the server and changes in the internet address of servers can be easily and efficiently updated without having to update the memory of each terminal.

The global upgrade server 38 updates the terminal address register 36 each time there is a change in the association between a terminal and a server; e.g., when there are new terminals to associate with a server, if the internet address of a particular server is changed, and/or if the ISP address of the terminal is changed.

Referring again to FIG. 1 and 1b, with internet address of the terminal address register 36 stored in the memory of the terminal 20, the terminal 20 is able to request and retrieve the internet address of the server 28 or the ISP 24 from the terminal address register 36. The terminal address register 36 stores information about the location of the server 28 or the ISP 24 and possibly all other servers or ISPs in the network and the corresponding relation between each terminal and its server. Thus, the terminal 20 is always able to obtain directly or indirectly the address of the server 28, which is the server designated to serve the terminal 20, the associated ISP 24 with whom the operation network subscription has been made, the MSP, or the AP unit 22. For example, the terminal 20c coupled through AP unit 42 to an ISP 44 can retrieve the Internet address of the server 28, the ISP 24, or even the AP units 22 and 22a from the terminal address register 36, provided that the server 28 is the designated server for terminal 20c. The terminal 20c is authenticated by the access point unit of the AP unit 42, the server of the ISP 44, or the server 28 as an authorized user in a manner similar to the authentication process described above for the terminal 20.

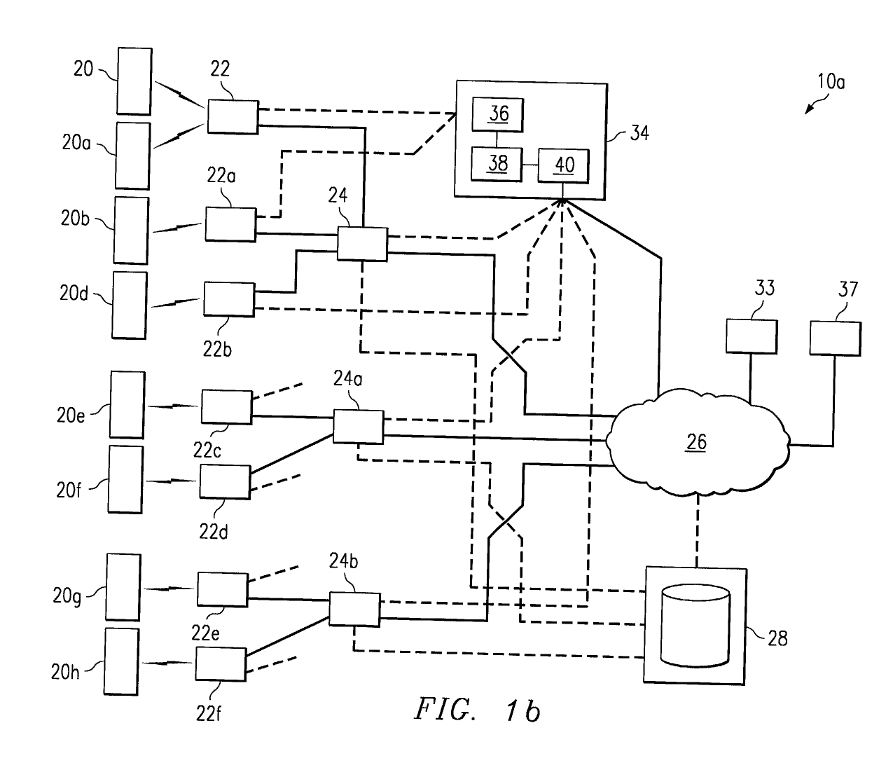

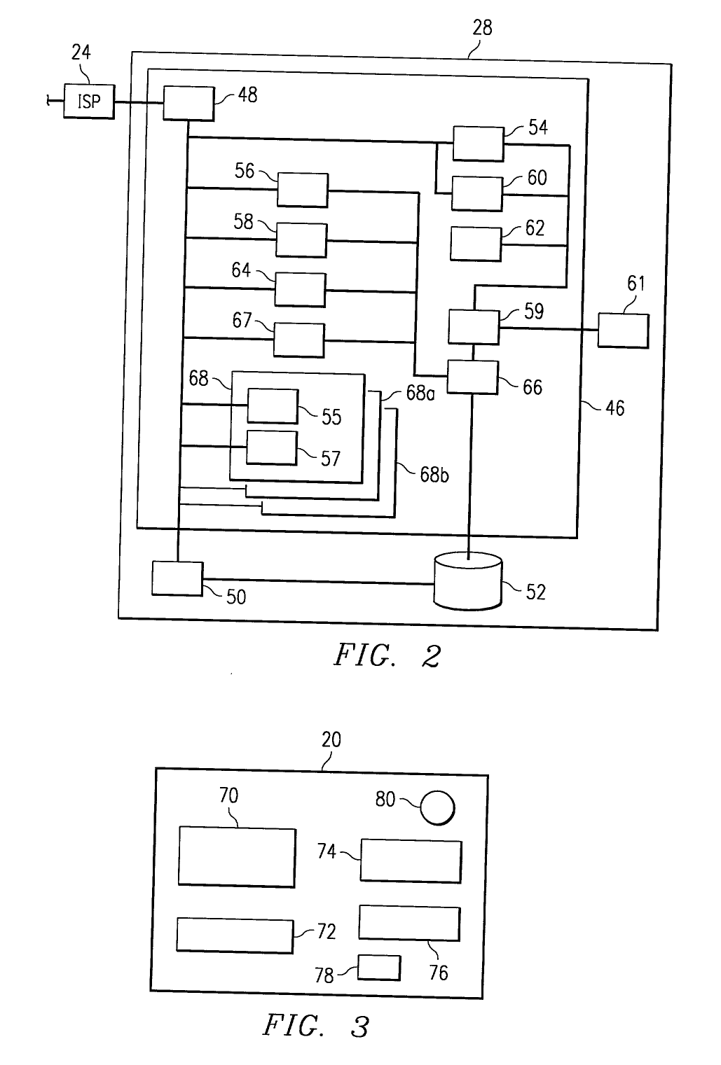

Referring now to FIG. 2, the server 28 includes a support server 46, a response handler or application server that can also be called an external connection server 48, a network application server 50, and a directory server 52. It will be apparent to those skilled in the art that the referenced connections do not depict the physical connections between the logical elements; the emphasis is merely on the logical connections. The support server 46 provides services oriented toward enabling and supporting the services provided to the terminal 20. The support server 46 includes an upgrade service unit 54, a bookmark service database unit 55, a login services unit 56, a bookmark database 57, a profile services unit 58, a client log unit 59 for collecting information about clients, and included in web browsing client object specific units 68, 68a, 68b, a system log unit 61 for collecting information about events in the server 28 from the client log unit 59, an advertisement services unit 60, an administrative services unit 62, a defined services unit 64, and a directory client unit 66. The remote register management and control unit 67.

Support server 46 also includes as many web browsing client object specific units 68, 68a, 68b as required to support all the individual and concurrent web browsing sessions, the user terminal group profile, and the individual terminal user profiles. The profiles that are served may, for instance, belong to users with separate terminals on the same premises.

The upgrade service unit 54 is for controlled upgrade of the software from the server 37 or the global upgrade server 38 for the support server 46. The upgrade server unit 54 is a logically independent functional entity and may be located on a separate server from the support server 46. Updates are transmitted from the global upgrade server 38 to the upgrade service unit 54. The global upgrade server 38 and the system server 37 can upgrade any software component, perform a full executable software program, or reconfiguration of application and system parameters.

The login services unit 56 provides for authentication of the user and the terminal 20 that is being used to access the services based on information provided by directory client unit 66. Additionally, the login services unit 56 is responsible for log-off activities, such as group and or individual session termination.

The profile services unit 58 provides for modifying a user's profile information, e.g., group and individual information and preferences. The administrative services unit 62 provides for administration of the support server 46 and the application server 48. More specifically, the administrative services unit 62 may include the functionality of client object specific units 68, 68a, and 68b, as well as the upgrade service unit 54. The advertisement services unit 60 provides for the server 28 to tailor advertisements to the user and the terminal 20 according to the user's profile information. The defined services unit 64 is a classification of other services containing items like bookmark management services, help services, log services, name management services, and general management services.

The directory client unit 66 is coupled to the directory server 52, including the databases of the server 28 and its included servers, to provide client verification. The client object specific units 68, 68a, 68b, of the web browser, control the terminal session specific section of the client side, which cannot be shared between multiple and individual browsing sessions. Such items or parameters, which cannot be shared with other active terminals but are individual for each terminal, include cookies, accessed Internet site addresses, such as the URLs that are saved for future use in bookmarks, and history of addressed Internet sites.

A software program of a browser at the server 28 includes web browsing client object specific units 68, 68a, and 68b to support all the concurrent individual web browsing sessions of a group profile concurrently sharing the same browser program sections in the server 28. All the service specific parameters, which are transferred between the terminal and accessed network site, and services activated or in use are downloaded from the site. The service specific parameters of the group shared services and the individual services include system parameters that support terminal specific and other user hidden parameters of client object specific units 68, 68a, and 68b and a group of application specific parameters, which can be seen and controlled by a group user or the group administrator. The group user is controlled by a group profile enabling the group or shared services. The individual user is controlled by an individual user profile enabling the individual services to be used. The application specific parameters are managed in a remote server by a network application server 50 and are used during a session. The system parameters of the service specific parameters are used during a non-system terminal session, such as the PC terminal 21, and a system terminal session. The above identified list of parameters is not intended to be exhaustive and other information can be controlled and temporarily handled in terminal specific dynamically created client object specific units 68, 68a, and 68b. The advertisement services unit 60 includes, but is not limited to, picture information of still pictures or links and identification information. The actual advertisement information physically resides in the directory server 52 or elsewhere in a server memory medium. The advertisement information may be a video clip, together with image(s) and other advertisement information. Such advertisement(s) may include accessible internet site addresses(s) as well as the URL(s). A presentation management information unit controls how the data is shown in the user interface of the terminal and may reside partly or totally in the advertisement services unit 60 and/or the administrative services unit 62. Other arrangements in the server 28 are possible with regard to advertisement information, the advertised product itself, and additional control information of that product.

Referring now to FIG. 3, the terminal 20 includes a display 70, a user interface (UI) framework 72, a browser 74, a driver 76, and hardware 78. The driver 76 resides in the memory of the hardware 78 along with other data, such as the internet address of the terminal address register 36 and software, such as the browser 74. As the terminal 20 is turned on, the driver 76 retrieve data relating to the internet address of the terminal address register 36. In this embodiment, the driver 76 is EPOC6, which is an operating system software that handles hardware-related functions in the terminal as well as offering a functioning environment for the application layer programs. Once the terminal 20 is powered on, it is coupled to the access point of the AP unit 22 and the ISP 24. Thus, the terminal 20 is able to obtain its own internet address.

In full web browsing mode, the remote server allows login and usage of the browsing services without dedicated authentication. A determination as to whether each activated terminal is allowed to be used in the terminal system or browsing services may be made to prevent fraudulent usage.

Using the internet address of the terminal address register 36, the terminal 20 is coupled to the terminal address register 36 and sends a request in order to obtain the internet address of the server 28. Once the terminal 20 has obtained the internet address of the server 28, it is then coupled to the server 28. Using the unique identity of the hardware 78 of the terminal 20, the server 28 authenticates and determines if the terminal 20 has group level access privileges. Once authenticated, the terminal 20 is logged onto the server 28 to begin a shared session at a group level. Thus, the user can now access services or retrieve information from the server 28 or the Internet 26. In order to initiate an individual session and retrieve individual information, the user must provide further authentication, such as a password, from the UI framework 72 of the terminal 20, to gain access to the individual level as defined according to the user profile. It will be apparent to those skilled in the art that at either the group or the individual level, the user is able to the retrieve information related to the group, as well as browse the Internet 26 to retrieve information.

The browser 74 is a typical browser and includes such features as HTTP, JAVA script, and cascade style sheet capability. As with typical PCs, the browser 74 helps the user navigate through and retrieve information from the Internet once the user is connected to the ISP 24 through the terminal 20.

The user utilizes the terminal 20 to connect to both the ISP 24 and the server 28 using authentication protocol, as discussed in detail herein. The terminal 20 is the primary means of access by the user to the server 28 and the related services and applications offered thereby. However, the user can also access the ISP 24 and the remote server 28 using the terminal 21 or any other non-mobile terminal using appropriate group level authentication initiated manually.

A global validation register of terminal identifications may reside somewhere in the network. The rejection register may also be a part of the global validation register where stolen terminals are listed. Alternatively, these can be separate registers. The global validation register may also be distributed closer to a WLAN network, in that each of the distributed global validation registers include similar list of terminals for which service need to be rejected. A service operator can update that terminal validation register address to the server 28. The distributed rejection register may be part of and managed by the network operators or the distributed rejection register may be managed and located elsewhere in the network 10 and connected to the MSP, ISP, or AP via the Internet 26. If terminal rejection register is a mandatory feature, then it can be done before optional feature authentication of the individual user profile before the access right check out is performed.

Another alternative would be to request terminal validation in parallel to authentication checking or after the authentication is performed by the server 28. According to network management requirements and depending on the grade of service offered server 28, the terminal 20 may start full browsing session without the server 28, or before the terminal 20 is authenticated and has logged onto the server 28 to begin a group layer or a family session as specified according to the group profile in the server 28. If the user requests individual profile support and the user login is successful, then individual user profile, information, and enhanced services may be offered to the user. Thus, the user may now access the basic web browsing services shared with the group and or individual user services as well as retrieve information from the server 28 or the Internet 26.

In order for the user to initiate an individual session and retrieve individual information, the user must use the terminal 20, and depending on the specific security configurations, also provide further authentication to the server 28 in order to gain access at the individual level. It will be apparent to those skilled in the art that at either the family level or the individual level, the user is able to browse the Internet 26 to retrieve information.

Even though the virtual keyboard is used as the user retrieves information from the Internet 26, such as a web page, the user can receive the information at the display 70 of the terminal 20 in a full screen format. Full screen format is available because the UI framework 72 disappears when the user types a URL or follows a hyperlink while navigating the Internet 26.

The user is returned to the UI framework 72, when the user presses a button 80. Then the virtual keyboard as well as the header and footer related to the services are presented again. Additionally, once the user presses the button 80 the web page, which was a full screen displayed prior to pressing the button 80, is reduced to a thumbnail view and positioned in the display 70, such as in the bottom left corner of the footer. Consequently, the user has a shortcut to quickly access the web page that was previously visited or to save that web page as a bookmark.

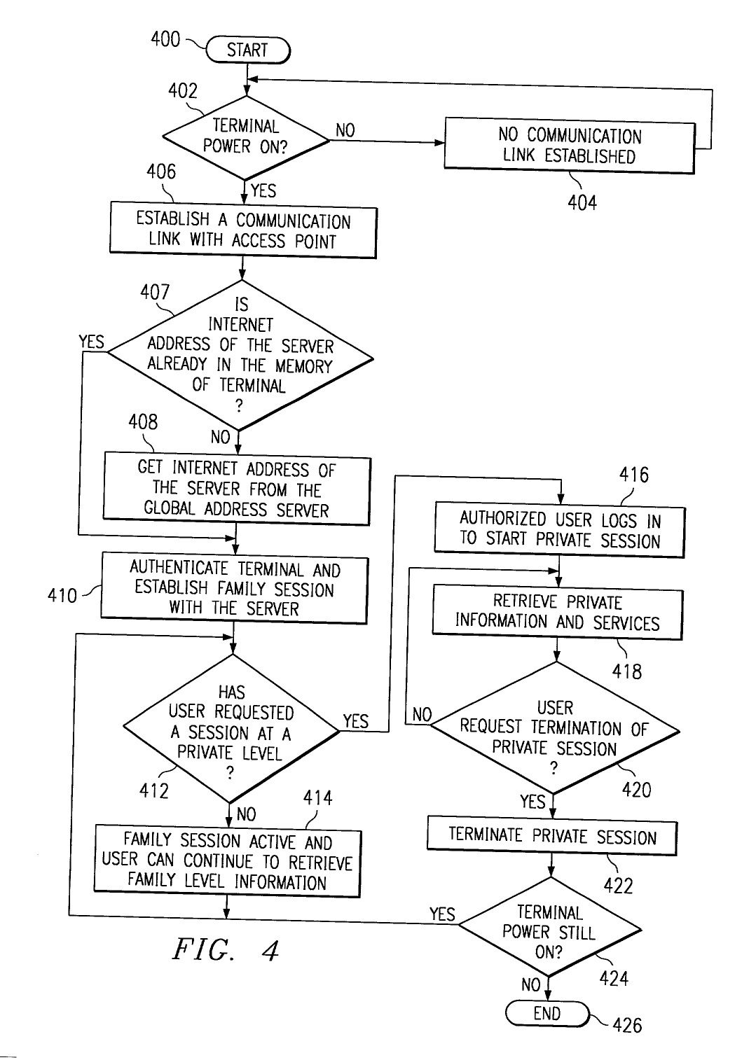

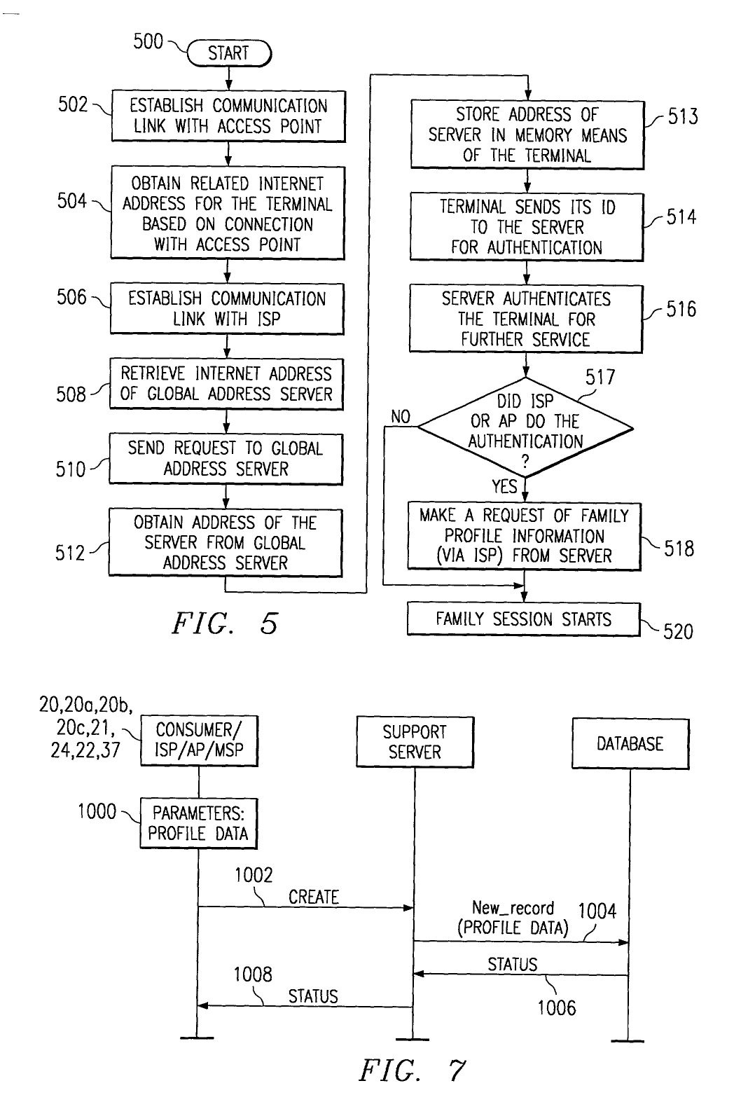

Referring now to FIG. 4, the process of authenticating a terminal at the group level to initiate a shared session and authenticating the user at the individual level to initiate an individual session, beings at step 400. At step 402, it is determined whether the terminal is powered on. At step 404, if it is determined that the terminal is not powered on, then a communication link cannot be established through an access point of an AP unit to a server, and hence, the process returns to step 402 until the terminal is powered on. On the other hand, if the terminal is powered on, then at step 406, the terminal establishes a connection to the access point, and hence, to an ISP and a GAS. At step 407, it is determined if the terminal knows the internet address of the server. At step 408, if the terminal does not know the internet address of the server, then the terminal obtains the internet address of its server from the global address server. As a result, the server's internet address is received and a connection from the AP unit to the server can be established. A request includes at least a terminal ID. The request is sent to a login services unit in the server and an answer that includes the services allowed is returned. Alternatively, if it is determined at step 407 that the terminal knows the address of its server, then the process proceeds to step 410. The functionality in step 410 contains at least authentication check up in the server, i.e. the terminal ID is one to be served by this server, and thus, resulting in initialization information for login process to be located in the server. The terminal communicates with the server and is authenticated as an authorized terminal with access to information and services at the group level and the shared session begins and continues until the terminal is turned off. Additionally, a group profile is downloaded to the terminal when the shared session is active. Once the server recognizes the terminal, establishing the shared session is an automatic background activity carried out by the terminal and transparent to the user, which is discussed with respect to FIG. 5.

In order for the user to establish an individual session and access individual information and services, the user has to log in as an individual user at the individual level. At step 412, a check is performed to determine if the user has requested a private or an individual session correctly. In other words, has the user already given or has the user been requested to give a user password, or symbol sequences standing for a password, while the previous remoter address requests and terminal validation procedures were processed in the server.

At step 412, it is determined if the user is an authorized individual user. At step 414, if the user is not authenticated as an individual user, then the user will only be given access to the shared session and the group level information and services. On the other hand, at step 416, if the user is an authorized individual user, then an individual session is established and the user is allowed access to the individual information and services. Although the individual level information and services may be the same for all users, the content will vary from user to user.

At step 418, in the individual session the user retrieves information and uses the individual level services provided by the server. At step 420, it is determined if the user wants to terminate the individual session and return to the group level. If it is determined that the user does not want to terminate the individual session, then the user continues the individual session at the individual level and the process returns to step 418.

On the other hand, if it is determined that the user wants to terminate the individual session, then at step 422, the individual session is terminated and the user goes from the individual level to the group level. At step 424, it is determined if the terminal is still powered on. If the terminal is powered on, then the process returns to step 412 with the user being at the group level in a family or shared session. Otherwise, if the terminal is turned off, then the shared session is also terminated that the terminal is logged off of the server and the process ends at step 426.

Thus, once the server authenticates the terminal, a shared session begins at the group level; once the user is recognized as an individual user, then an individual session can be initiated. Consequently, an individual session remains in effect until the user explicitly terminates the individual session, whereas a shared session remains in effect until the terminal is turned off. Additionally, during a shared session when a predetermined period of time expires without any input from the user, then the terminal can enter standby mode in order to conserve batter life until the terminal receives an input, of any kind, from the user. Other features can be included, such as termination of the individual session if no input is received from the user after a predetermined period of time.

Referring now to FIG. 5, the process of establishing a communication link to the access point, which corresponds to step 406 of FIG. 4, and obtaining the internet address of the server for that terminal, which corresponds to step 408 of FIG. 4, for initiating the shared session at the group level begins at step 500. At step 502, the terminal establishes a communication link with the access point. At step 504, the terminal obtains its internet address from the access point based on the internet address of the access point with which the terminal has established the communication link. At step 506, the terminal establishes the communication link with an ISP, which is coupled to the AP unit. At step 508, the terminal retrieves the internet address of the global address server from its memory. At step 510, the terminal sends a request to the GAS for the internet address of the server that is associated with the terminal. At step 512, the GAS returns the internet address of the appropriate server to the terminal. At step 513, the internet address of the server is stored in the terminal's flash memory. At step 514, the terminal sends its identification information to the server located at the internet address provided by the GAS in order to establish a communication link with the server. At step 516, the server authenticates the terminal and the shared session at the group level is established between the server and the terminal. The family session establishment may be done in alternative ways in which the AP unit or the ISP does the authentication, at least in part, and addressing and request made for authorization can be done differently when compared to the alternative in which the server does the authentication. However, other addressing arrangements are contemplated without departing from the scope and spirit of the invention.

The service provider or network operator has enhanced techniques to offer to the user of the terminals by downloading software program versions or part of the programs, which are of a different version than the latest available software products. The group and or the individual user wanting to have the newest services will have a chance to get them so that either the latest software can be accepted and requested periodically from the terminal or being able to accept the update every time new products are offered or available.

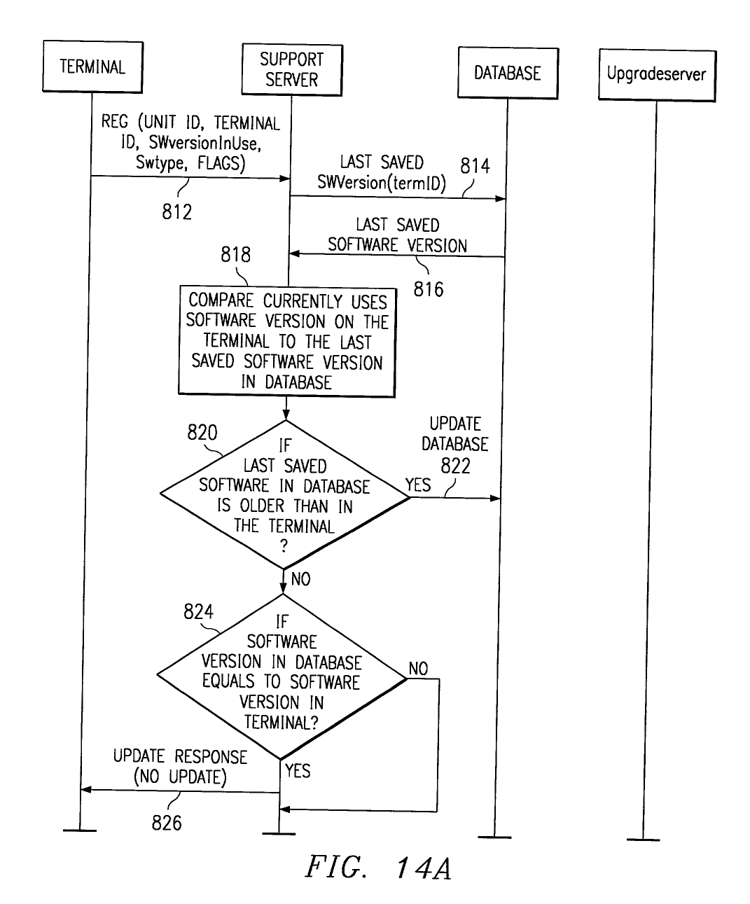

Referring now to FIG. 13, a signaling flowchart of software (SW) release distribution from a global source is presented. The upgrade service unit asks the global upgrade server, if new SW releases are introduced, by sending a request message 800. The global upgrade server answers the upgrade server with a message 802 containing a SW release number. The received SW version number is compared to an existing number in a comparison block located in the upgrade service unit of the server, in step 804, and if the global upgrade server has a SW version number that is newer than the existing one, then the upgrade service unit asks the newer version to be downloaded in request 806 and receives, as an answer, the newer version of SW at response 808. When the upgrade service unit has received a newer version of any SW component, application, or service program, it informs the support server about the newer SW being available, with a message 810, that is ready to be distributed to other terminals if required.

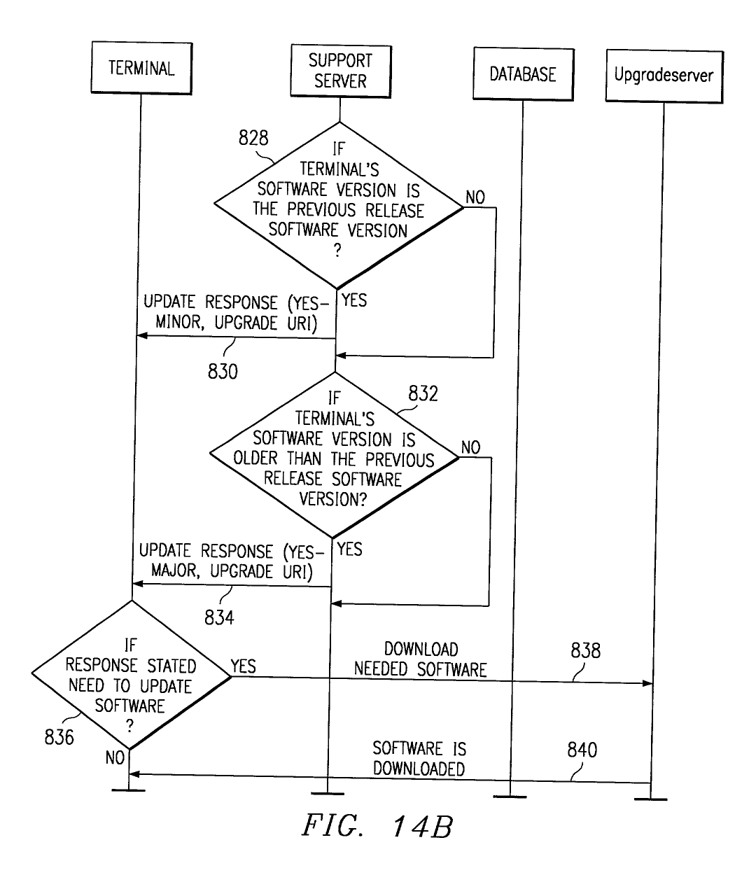

Referring now to FIGS. 14a, 14b and 14c, a signaling flowchart for terminal SW upgrade is shown starting at FIG. 14a, which continues in FIG. 14b and FIG. 14c. The new SW was downloaded from the global support server to the upgrade service unit. The support server has also been informed by the upgrade service unit of any available new SW components or programs. Now when any terminal requests if newer SW products or a component are available, as in step 812, the support server retrieves from the database latest SW version of the requested SW, as in steps 814 and 816. The support server compares the SW version received from the database to the request message received information, at step 818, in a comparison block located in the support server. At step 820, if the terminal has a newer SW version than the SW in the database, then at step 822, the terminal's SW is saved in the database. If the existing SW version in the terminal is the same as the version of the SW in the database at step 824, no database update is required. At step 826, if the terminal had the newest SW version, then the terminal is informed that no SW update is required.

If the terminal's SW version turned out to be an older version, then at step 828 the terminal is informed that a SW update is required, at step 830. If the terminal's SW version is much older than the previous SW version, then at step 832 the terminal is informed that a major SW update is required 834. After the terminal has received the required update message from the support server, then at step 836 the terminal asks for the SW download, at step 838, and as a result of the SW download request, the new SW version is downloaded, at step 840.

If the terminal has requested and possibly received a SW version, then the terminal informs the support server that there is the need for updating the database with the new version of the SW at the terminal in step 842. If the terminal's SW update was successful, then at step 843 the database is updated, at step 844, of the new SW version to be included to the terminal and the support server is notified of the database update at step 846. The support server, in step 848, writes the SW version update that was requested by the terminal to the status log.

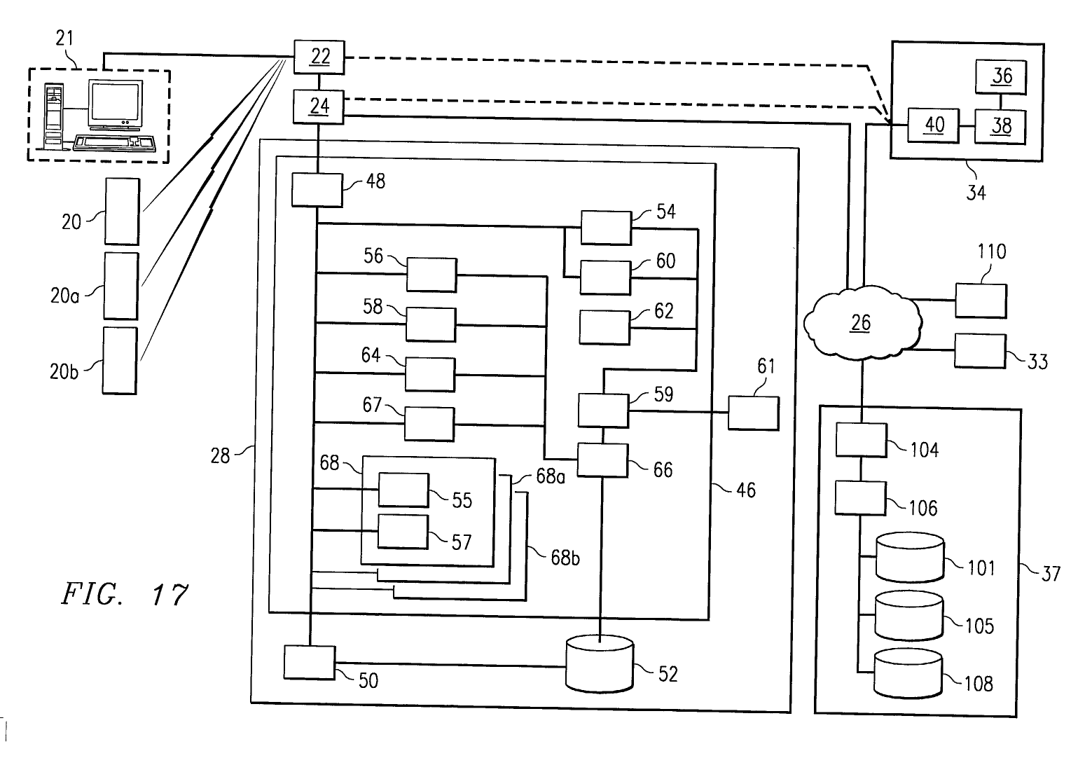

Referring now to FIG. 17, operation and maintenance (OAM) management is described in more detail. The AP unit, the ISP, the Mobile Service Provider, and the content provider or system product vendor may have specific configuration update right and method to support the configuration change whenever the site is reconfigured and/or their network is re-arranged.

The OAM of the terminal is done by an OAM server 37, which is part of the network of the MSP. The MSP can be a separate organization from the ISP or the same company. The AP unit, the ISP, the Mobile Service Provider, and the content provider or system product vendor may all have some OAM management events, such as update, keep log, and re-configure certain user or group services and/or applications. For simplicity, only one OAM server for a product vendor is shown, but a distributed OAM structure of servers can exist in the network 10. The OAM server 37 typically includes several databases, of which at least one contains information and reports collected from the network 10. Block 101 is a statistical database and block 105 is a configuration database. Connections to the network 10 go through a firewall unit 104. An OAM upgrade server 106 includes configuration tools of the system and can be a centralized unit of the OAM server 37, which controls all connections and control of all databases 101 and 105 and have all necessary functionality to support all OAM action required in the network 10. Also, a separate database 108 contains advertisement control information.

The statistical database 101 contains statistics of malfunctionality that occurred in the network 10 and any other events to be traced or recorded. The configuration database 105 may also contain detailed information of the terminal user subscriptions and terminal user information, such as name and address. The non-technical type of information may reside some where else in the network 10 instead of in the OAM server 37.

Also charging and billing information may be gathered in a billing system that can reside in the network 10. The billing can be handled in an external server if the MSP has an agreement or contract for such services and externalized that part of the business. The charging reports may be collected in the statistical database 101 and conveyed to an internal or external billing system.

Typically, the OAM server 37 tracks old and new configuration sets of software packages of each remote server and terminal that is sold when a network service contract agreement is made with the terminal. The agreement is typically made when a terminal or a remote server is bought. Depending on what kind of end customer agreement is made, different configuration parameters are downloaded to the remote server. The contract may include a direct link to an internet address or an advertiser's site. The advertiser may want to collect statistical data about the advertisements and any other statistical information relating to the terminal and user behavior.

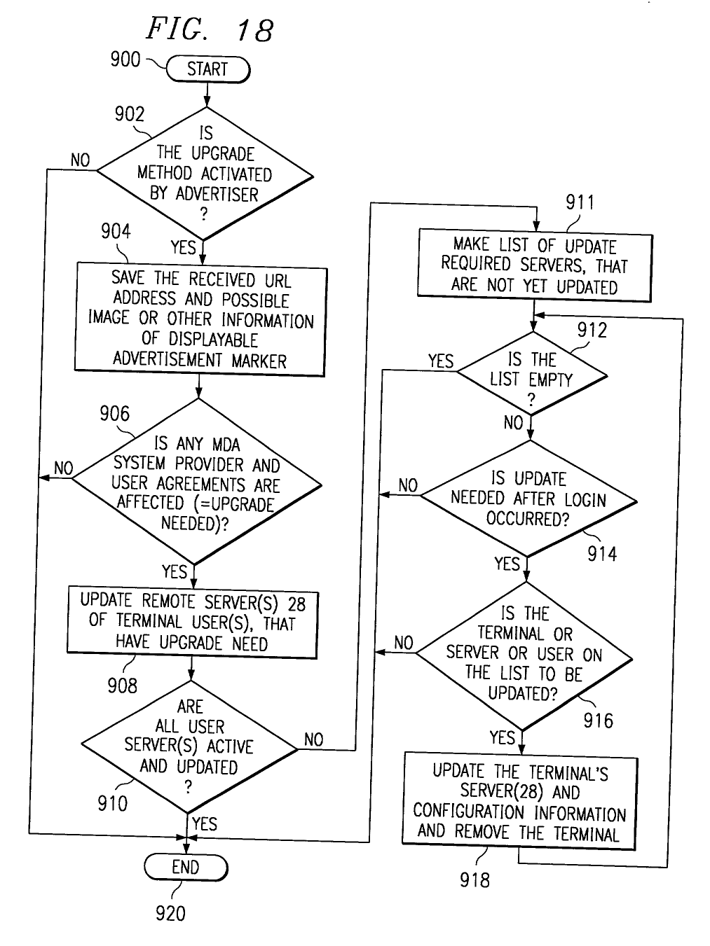

Referring now to FIG. 18, a flowchart of one specific method comprises several steps, which may be activated from an OAM upgrader server of an OAM server, or it may be activated from the server of an advertiser. At step 902, if an upgrade initiator is by the advertiser, then advertisement control information, like a URL address, is received at the OAM upgrade server of the OAM server. At step 904, the received information is saved to a database. Then at step 906, the OAM upgrade server determines what kind of end user agreements contain this upgraded advertisement control information, which reside locally in the advertisement services unit of the server. At step 908, all the users having that contract will be upgraded, which means that a configuration upgrade message including required control information is sent to those servers and advertisement server units. At step 910, the OAM upgrade server removes all the remote servers, terminal ID, or both from the upgrade-needed control list and determines if any server is left non-upgraded after a certain time and makes a list of non-upgraded servers at step 911. Whenever such a server starts login initialization as a result of terminal being powered on, the server makes a check up request from the OAM upgrade server. The server makes a check-up request immediately after the terminal is authenticated or a certain period of time has lapsed; alternatively, the check-up request can occur once the OAM server has acknowledged the server with the configuration upgrade status and/or changed configuration information.

Referring now to FIG. 7, when a new user starts to use the applications and services of the system, then an individual user and a multiple user or family user profile is created. The operator or provider may create an individual or family user profile. Also the individual user, who is configured to have administrator rights, may create a new user profile to be a member of the family. The required user or group profile is created in step 1000 by providing detailed information of the new profile to be created. A create request 1002 is sent to the support server that manages all user profiles. A predefined default user profile configuration is used by the support server when the new user profile is created. Alternatively, all of the user profile configuration can be downloaded from the provider. The new user profile is created in the database of the server. The database could be located in another network element different from the server. At step 1006, database acknowledges the create request by giving a status message 1008 of the transaction to the support server. The support server provides feedback to the management server of the provider or the family administrator that the create request was a success.

The family profile is read from the server when the terminal logs on. The individual user profile is read from the support server when the user gives access rights to log-in the individual applications and services or when the user log-ins to the support server by using the PC and modem connection and by providing individual access right information. Also the OAM server of any operator of the system architecture may read the user profile information when the reading rights of the profile data is enabled for the reader.

Referring now to FIG. 8, a signaling flowchart of the method to read an individual or family profile is shown. The user profile reading is initiated by specifying the profile either with the terminal identification information or with user identification depending on the terminal. Also any other profile specific information may be giving as read selection criteria, which may result in a set of user profiles sent back to the inquiring party 20, 20a, 20b, 20c, 21, 24, 22, and/or 37.

The support server reads record of the user profile, 1024, from the database. The data, one or a set of user profiles, that is found from the database according to giving user profile selection criteria is returned to the support server, 1026, and finally back to the initial request made party, 1028. Typically when log-in is made the reading criteria is terminal identification or user identification, which results in one individual user profile or family profile to be fetched from the database to be further used in the support server while the log-in session is active.

When the group profile or services settings are changed, the later activated terminals of the group are enabled to use the updated profile of the group. This can occur when there is changed user interface configuration or a new object has been created in the shared applications and services. When application content information is changed and the family profile is in use, the changed application view is applied when another family member accesses the application in the same level as the change was made. The updated application content is accessible from the server when a shared family user profile is used by another family member and the newest information of the content is always fetched from the server to the terminal if the user uses the same application as the previous family member used. Alternatively, a member of the family may change overall user interface look, for instance by changing the used language or any user enabled changes in colors and backgrounds in the terminal view; not all the changed content and/or family profile changes are available to the next log-in family member, unless the previous member updated the profile or has logged out from the family user profile. The next family member can get the newest family user profile and all of the latest services and application content available meaning, that full synchronization of the shared family information according to the group family user profile is supported.

The administrator is able to tailor the services and the user interface of the terminal as well as do some content orders for the group. Also, the group administrator can be changed to be another user of the group. If a user terminal is not a member of the family terminal, then the terminal can be removed from the family profile.

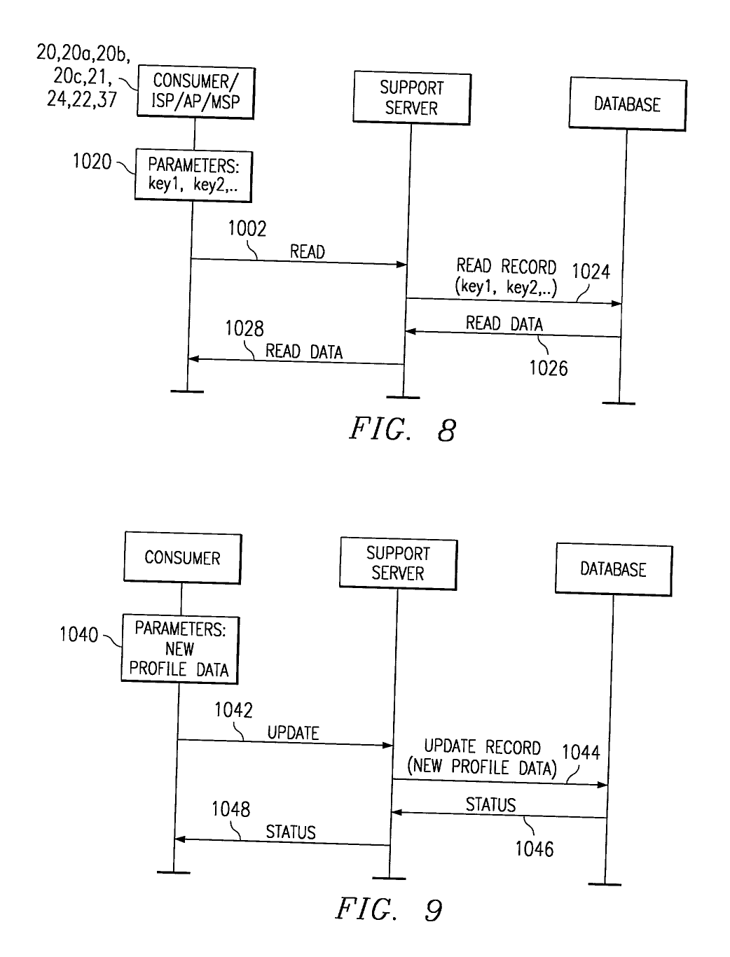

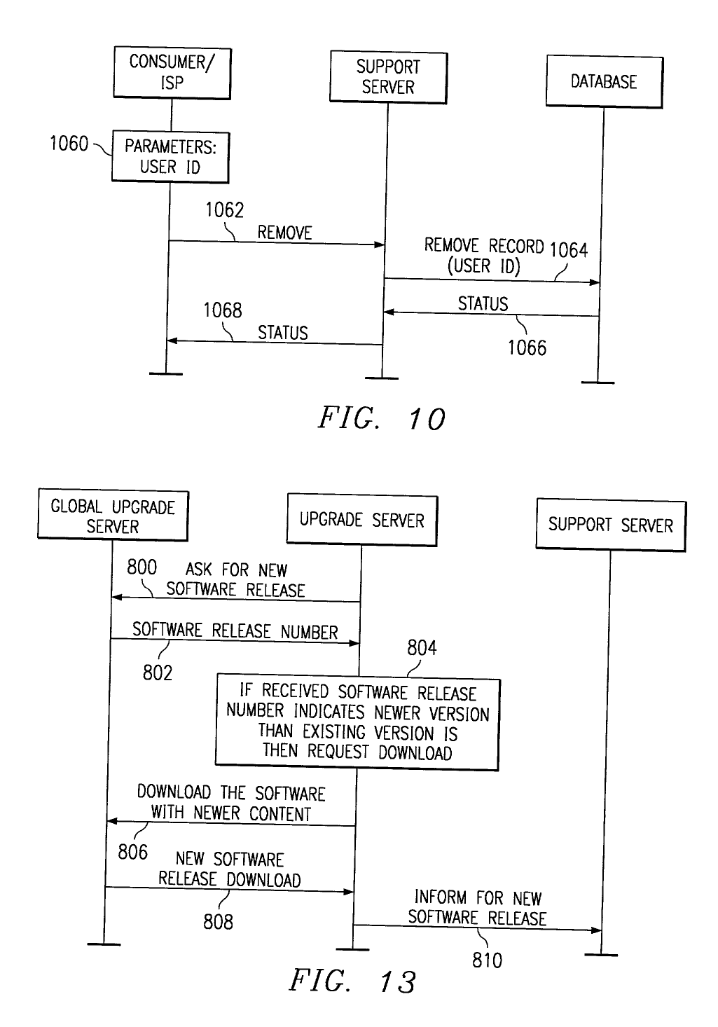

Any change in individual of family user profile can be done, as presented in FIG. 9 signaling flowchart, to update a profile. The manager of the system can make a change to the user profile if erroneous situation has occurred or family is provided different service than earlier because service subscription may have changed. The profile change may be done by an individual user of the terminal, a member of a group, an administrator of the group, or a provider of an OAM task. The profile change is requested, 1040, by giving a new parameter as input, which will change the existing user profile. The support server sends profile update request, at 1044, to the database and status result of the request is acknowledged back to the support server at 1046. Final status to the initial profile change request is given back to the initial requester, at 1048.

Whenever a user profile needs to be deleted, for instance when long time visitor of the family moves away from the household, the individual user profile is deleted from the server. Also if the server and possibly the terminals are sold to another group of users the existing user profile is deleted. Also, the MSP (or AP or ISP) vendor may end the service contract, and thus, either delete the user profile or change it in such a way, that authorization rights to use the and services are no longer certified to be used.

In FIG. 10, the individual or group profile is deleted and removed from the server and the database. The user ID is used as source information to identify the user profile that is to be removed, at 1060. The remove request 1062 is received by the support server, which initiates database update by removing the user profile record from the database 1064. As a result of deleting the user profile record from the database, the support server receives status indication of the requested and processed event 1066. The final status to the initial profile delete request is given back to the initial requestor 1068.

The network with mobile terminals provides information management and internet accessibility in such a way, that the terminals can be offered web browser capabilities serving each user session independently of other similar terminals through the server. The server side is a shared resource with the group members and each individual terminal user. The terminal, which includes a browser, is a shared section of a server client entity, with each terminal session sharing the same group profile and/or services in the server in such a way, that each user terminal will have cookies, bookmarks, and browser history information. For each terminal including browser functionality there is one server client entity in a server and multiple clients of each terminal session of the group, that do not share same profile, or alternatively, not all the parameters of the service usable for the activated family profile.

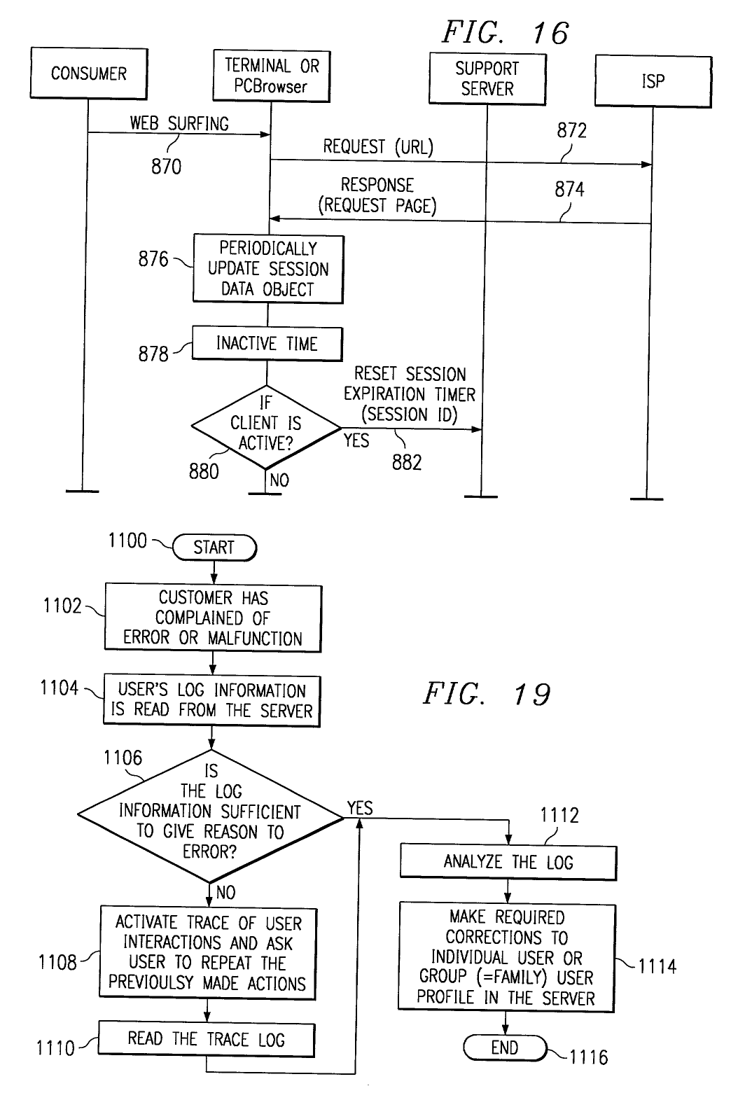

Referring now to FIG. 16, a signaling flowchart of a user surfing with the browser in the internet is shown. First, the user of the terminal initiates WEB surfing 870 to be started resulting in the terminal sending URL requests 872 via the support server to the Internet via the ISP. As a response to the URL address send request, the page information of the requested address is transferred to the terminal 874. The session data object is then updated 876 periodically until possibly the user selects a new URL address. If no new URL is selected or given by the user of the terminal, then the inactivity timer 878 runs until the user activates the browser by giving a new request including a URL address. If the user request is given to the terminal the session expiration timer (STS) is reset 882 or if the STS of the session object is invalidated.

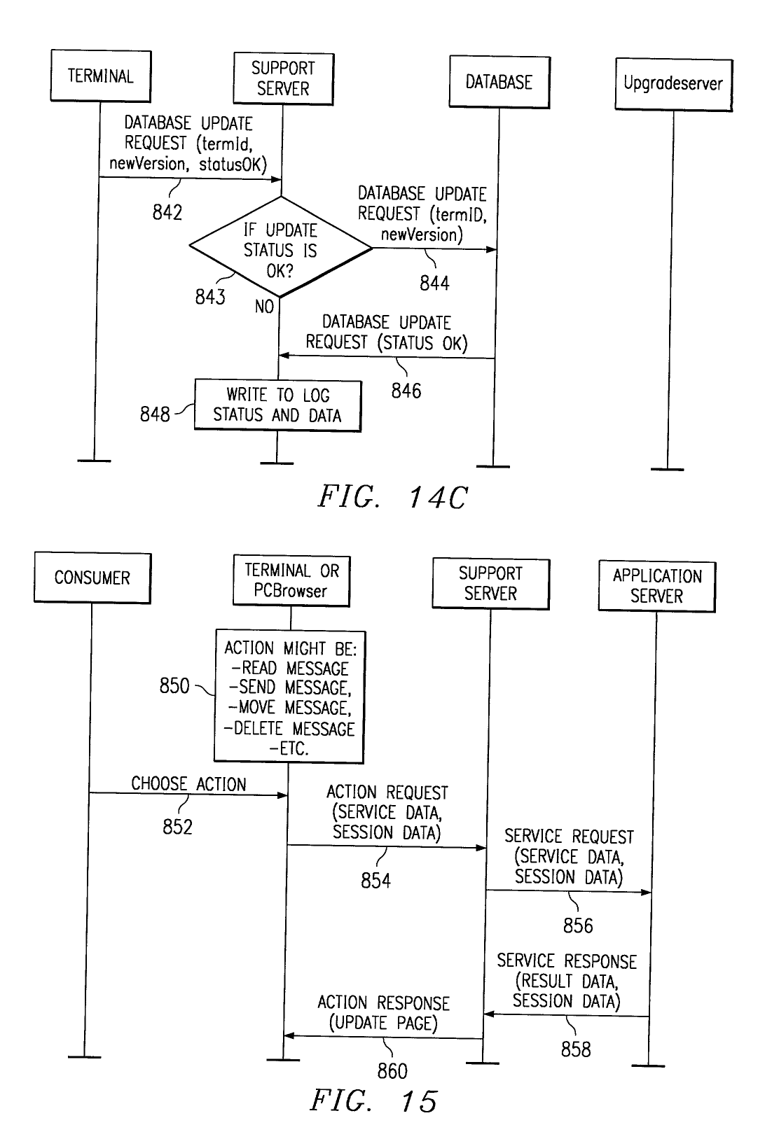

Referring now to FIG. 15, a signaling flowchart of a consumer using a system service application is shown. Each application of the system, such as calendar or e-mail application, that is used either as an individual or as a group application uses the following basic functions: read, send, move, and delete as action events to be directed to a user selected application object at step 850. As shown in the example diagram of e-mail application, after the user selects an object the user, at step 852, gives the action that is directed to the selected object. The action request is sent from the terminal to the support server of the server at step 854. The support server directs the request to the application server of the server with the received user selection information, which was initially received from the terminal, at step 856. The application server processes the request and the information, including responding back to the support server, at step 858. The support server updates the page information that was received from the application server and sends the updated page information to the terminal in step 860. If the action in the initial action request 854 and the chose action 852 was, for instance, a delete message, and if the response was successful, then the updated page includes information that indicates the page has disappeared from the view.

The AP unit, ISP, the MSP, or system product vendor may act after getting complaints to correct malfunctioning in the existing user terminal and server system configuration. The party that has OAM responsibility for the problem area has the ability to make corrections to existing systems to the terminal and or server configuration. The OAM responsible party may have some report feedback from the system. The party may activate a problem test to get information feedback of the problem in order to handle OAM activities.

Referring now to FIG. 19, general customer care procedure, that is done by the operator's personnel from the OAM server begins at step 1100. The statistical database contains statistics of malfunctionality that occurred in the network and any other event occurrences to be traced or recorded. The statistical database collects traffic measurement reports from the connections to such network units like servers, global address registry, and any other system network entities. The statistical database collects information about the traffic sent and received in the server, to and from a specific terminal. The configuration database may also contain detailed information of the terminal user subscriptions and terminal user information like name and address and copies of the first created or so called default user profiles of an individual or family group users.

At step 1102, the operator's customer care has received a complaint from a customer either as an ordinary phone call or via e-mail or the complainer has been able to fill in a complaint form in the internet address of customer care pages. Also, it is possible that a terminal or the server includes a control block that notices or forecasts problems and automatically sends, via the internet, a notice of possible trouble to the OAM server. At step 1104, the operator's personnel or a control block in the OAM server reads the log of the latest event transactions from the server. Each phase may be initiated by the operator's personnel at an OAM center where the person has connection to the OAM server and remotely to any server in the network. Alternatively, each phase at OAM server may be controlled and initiated by a program control block, that is located in the OAM server. If the log information that is read from the server is not good enough, then a trace or interception or recording function may be activated, at step 1108, to function in the server. The log of activated trace is read after a period of time or after it is confirmed by the customer that the problematic transactions was repeated after the trace was activated.

The OAM server analyses the received log or the log is analyzed remotely from the server, at step 1112. If the analyzed log requires corrections, at step 1114, the necessary changes are processed either by upgrading any SW component or program residing in the server and/or in the terminal. If the trace was activate to collect detailed log from the server, the trace is stopped at any stage after step 1110 or the trace may be left active for a certain period of time so that re-analysis of the problem may be made in order to be convinced the problem is corrected.

Although described in the context of particular embodiments, it will be apparent to those skilled in the art that a number of modifications to these teachings may occur. Thus, while the invention has been particularly shown and described with respect to one or more embodiments, it will be understood by those skilled in the art that certain modifications or changes, in form and shape, may be made therein without departing from the scope and spirit of the invention as set forth above and claimed hereafter.

What is claimed is:

1. A system coupled to a network, wherein the system comprises:
at least one terminal capable of wireless communication with the network through a gateway, wherein the terminal includes shared communication facilities for at least two users;
a server coupled to the gateway for providing services and information management services to the terminal; and
a global unit coupled to the gateway, wherein activation of the terminal is initiated by a request to the global unit.

2. The system of claim 1, wherein the global unit has an address of an access provider.

3. The system of claim 2, wherein the global unit has an address of a network unit, wherein the network unit is an internet service provider and the global unit authenticates the terminal for starting a shared communication session with a group profile once the communication connection between the authenticated terminal and the server is established.

4. The system of claim 1, wherein the terminal initiates authentication of the terminal before a shared communication session is established.

5. The system of claim 1, wherein the global unit comprises a global registry including the address of an access provider, an internet service provider, and a mobile service provider.

6. The system of claim 1, wherein the user is authenticated in a network node and wherein authentication is provided for a shared communication session based on information received from a global registry.

7. The system of claim 1, wherein a user of the terminal initiates a request for an individual communication session with the server.

8. The system of claim 1, wherein the terminal comprises:
an operating system including a driver;
a touch sensitive display coupled to the operating system for graphical display of information;
a user interface coupled to the operating system for providing the user with selection and input control; and
a browser coupled to the operating system for allowing enabled services to be selectable.

9. The system of claim 8, wherein the enabled services are located in a support server.

10. The system of claim 8, wherein the enabled services are located in an Internet.

11. The system of claim 8, wherein the enabled services are group and individual services.

12. The system of claim 1, wherein the server comprises:
a support server coupled to an internet service provider for providing the terminal with information management services, including access to messaging services;
a directory server coupled to the support server for providing directory services including authentication of the terminal and each user; and
an application server coupled to the directory server for providing application specific services.

13. The system of claim 12, wherein the terminal is authenticated by a network unit to start a shared communication session and each user is authenticated by the support server for starting an individual communication session.

14. The system of claim 12, wherein the application server transmits a group specific profile to the terminal of a specified group when a shared communication session is active and transmits an individual specific profile to the terminal when an individual communication session is active.

15. The system of claim 14, wherein the group specific profile and the individual specific profile include language selection unique to that profile.

16. The system of claim 14, wherein at least one individual specific profile has administrative rights to modify the group specific profile.

17. The system of claim 16, wherein at least one parameter of the services and the group specific profile can be updated by the user having the individual specific profile.

18. The system of claim 17, wherein the updated parameter is stored in a database of the server when a change session is terminated.

19. The system of claim 18, wherein after the change session is terminated, updated content is selectable from any terminal of the specified group.

20. The system of claim 12, wherein at least one parameter of the services and the group specific profile can be updated by any terminal that is part of the group.

21. The system of claim 12, wherein the support server comprises:
an application server;
an upgrade service unit coupled to the application server for receiving software upgrades from a global upgrade server;
a login service unit coupled to the application server for authenticating the terminal for a shared session and an individual session;
a profile service unit coupled to the application server for providing and updating shared session profiles and individual session profiles; and
an administrative service unit coupled to the application server for administration of the support server and a network application server.

22. The system of claim 21, further comprising an advertisement service unit coupled to the application server for configuring advertised services for the appropriate profile associated with the session that is active on the terminal.

23. A system of claim 21, wherein at least one parameter of the group profile and individual profile can be changed by the application server.

24. The system of claim 1, wherein the global unit comprises:
a firewall unit for providing secured access;
a global address server coupled to the firewall unit for storing the internet address of the server associated with the terminal; and
a global upgrade server coupled to the global address server for providing updated data, including software, to the server and the terminal.

25. A system of claim 24, wherein an upgrade service unit receives, from the global upgrade server, a software product comprising:
executable software;
at least one identification of the software product; and
an address of the server from where the software can be downloaded, wherein the global upgrade server responds to the server identifying from where the software product is available for downloading.

26. A method for providing a terminal in communication with a network, the method comprising:
coupling at least one terminal through a wireless connection to the network, wherein the terminal has shared communication facilities for at least two users;
establishing a communication link with a gateway to obtain an internet address for the terminal relative to the internet address of the gateway;
obtaining an internet address for a server to establish a shared communication session between the terminal and the server to allow access to information management services; and
downloading a group profile configuration from the server to the terminal.

27. The method of claim 26, further comprising authenticating the terminal.

28. The method of claim 26, further comprising configuring the terminal in accordance with the group profile.

29. The method of claim 26, further comprising:
requesting an individual communication session for the user;
authenticating the user to establish the individual communication session; and
terminating the individual communication session and converting to the shared communication session.

30. The method of claim 29, wherein the individual communication session is terminated upon expiration of a predetermined period of time without user input.

31. The method of claim 26, wherein the step of obtaining comprises:
retrieving an address of a global address server;
establishing a communication link between the terminal and an internet service provider;
sending a request to the global address server, wherein the request is a request for the address of the server;
receiving the address of the server from the global address server;
transmitting identification information unique to the terminal and the address of the terminal from the terminal to the server for authentication by the server; and
authenticating the terminal to establish the shared communication session.

32. The method of claim 26, wherein the step of obtaining comprises:
establishing a communication link between the terminal and an access provider;
retrieving an internet address of a global address server;
sending a request to the global address server, wherein the request is a request for an internet address of the server;
receiving the internet address of the server from the global address server;
transmitting identification information that is unique to the terminal and the internet address of the terminal from the terminal to a network provider that authenticates the terminal; and
authenticating the terminal to establish the shared communication session.

33. The method of claim 26, wherein the step of obtaining comprises:
establishing a communication link between the terminal and an access provider;
authenticating the terminal to establish a shared communication session by a network provider;
retrieving an internet address of a global address server;
sending a request to the global address server, wherein the request is a request for an internet address a mobile system server;
receiving the address of the mobile system server; and
transmitting identification information unique to the terminal and the address of the mobile system server received from the global registry to a network provider.

34. A method for providing a user with wireless access to an internet and information management services using a terminal capable of wireless communication with a server and a global address server through a gateway, the method comprising:
powering on the terminal;
establishing a communication link with the gateway to obtain an internet address for the terminal;
obtaining an internet address for the server that will be authenticating the terminal and downloading to the terminal the group profile configuration; and
establishing a shared communication session between the terminal and the server to allow access to information management services.

35. A system for providing a user with wireless internet access to a network through a gateway and information management, the system comprising:
a terminal coupled to the gateway, wherein, the terminal has shared facilities for at least two users; and
a server coupled to the gateway, wherein the server authenticates the terminal and establishes a shared communication session with the terminal in order to provide access to shared services to the user.

36. The system of claim 35, further comprising:
an internet service provider coupled to the gateway and an internet; and
an application server coupled to the gateway for providing access to shared and individual profiles.

37. The system of claim 35, wherein an internet address for the terminal relative to an internet service provider is requested from a global registry.

38. The system of claim 35, further comprising a content provider coupled to the gateway for providing an internet address associated with the server to the terminal.

39. The system of claim 38, wherein one user is authenticated as an individual user within a group and an individual communication session is established to allow the user to access individual information and data and wherein an individual profile of the individual user is downloaded to the terminal for configuring the terminal.

40. A software program executable by a system comprising:
means for requesting a software unit;
a global upgrade server coupled to the requesting means for answering a request for the software unit;
a network unit coupled to the global upgrade server and a server for carrying the request and a response message between the server and the global upgrade server, wherein the software unit includes a version identification of the software unit located in the global upgrade server ready to be downloaded; and
a comparison unit used by the server, wherein the comparison unit compares the version of the software unit that is received from the global upgrade server to a version of an existing software unit and if the existing software unit is outdated relative to the software unit, then the software unit can be downloaded to the server.

41. The software program of claim 40, wherein the server further comprises:
an upgrade server, capable of periodically requesting versions of the software unit from the global upgrade server; and
a support server coupled to and notified by the upgrade server when a new version of the software unit is available in the upgrade server.

42. The software program of claim 40, wherein the software unit is an executable software program ready to be executed in the server or in the terminal.

43. The software program of claim 40, wherein the downloaded software unit includes the version identification.

44. The software program of claim 40, wherein a control unit in the server compares the version of the software unit available with the version received in the request message from the terminal.

45. The software program of claim 40, wherein the terminal requests to download the software unit to the terminal.
